(19) United States
(12) Patent Application Publication
(10) Pub. No.: US 2009/0254318 A1
(43) Pub. Date: Oct. 8, 2009

(54) Simultaneous active and passive optical fiber amplification method

(76) Inventor: Jonathan Waisman, Richmond Hill (CA)

Correspondence Address: Jonathan Waisman, 12 Lebovic Dr., Richmond Hill, ON, L4E 5C6, CA

(21) Appl. No.: 12/385,017

(22) Filed: Mar. 30, 2009

Related U.S. Application Data
(60) Provisional application No. 61/072,380, filed on Mar. 31, 2008.

(51) Int. Cl. G06F 17/10

(52) U.S. Cl. 703/2

(57) ABSTRACT

The optimization process for pulsed laser experiments utilizing specialty optical fibers would normally require time exhaustive trial and error of many operating parameters such as cladding geometry, dopant concentration, and fiber length. With a scientific model that can be used to calculate simultaneously the active and passive effects on a time-varying optical signal, one can determine the optimal operating conditions relatively quickly.

I discovered a numerical method that calculates the simultaneous effects of a time and space dependent gain, amplified spontaneous emission, group velocity dispersion (GVD), self-phase modulation and cross-relaxation on a pulse modeled in the context of complex amplitude. The key feature of this method is in its capability to accurately account for both dispersive (GVD) and gain effects on an optical pulse as it propagates through an optical fiber amplifier medium. More over, this algorithm can be extended to include many more effects that are exclusively modeled by standard algorithms such as the split-step Fourier method (SSFM), or the shooting method.

### BACKGROUND OF INVENTION

The invention is a numerical method for optical fiber amplification that applies mathematical theory representing physical effects on an optical signal when it propagates down that optical fiber amplifier. There are two standard numerical models discussed below, each applying a subset of this mathematical theory. The two subsets of mathematical theory represent mutually exclusive calculations (i.e. calculations that cannot be performed at the same time). The invention bridges the numerical and theoretical gap to include all the significant physical effects in a numerical simulation, specifically the simultaneous effects of Group Velocity Dispersion, and optical gain.

Standard numerical models for simulation of optical fiber amplifiers incorporating active effects such as gain on a propagating optical pulse are readily available (see Reference 2). These can be used to perform causal simulations of fiber amplification on a time-dependent optical pulse as it propagates down the optical fiber amplifier.

The causal behavior of a pulse is time-dependent and is solved numerically up till the current simulation time step when the state of the system was numerically solved for all previous (contiguous) steps in time (i.e. via the rate equations of the dopant concentrations at all the relevant optical energy levels in the optical fiber amplifier and the radiation transport equations of the propagated pulse power samples).

The shooting method (as it is applied in Reference 2) models the causal behavior of the optical pulse propagating inside the fiber amplifier. In the shooting algorithm, a launched optical pulse is discretized in time by ‘N’ samples, each sample described with an optical power. Given the initial longitudinal concentration distribution of dopant atoms at each energy level in the optical fiber amplifier, the algorithm performs amplification calculations on this signal by first propagating spatially the power sampled at the first time step ‘0’ (where the discrete unit ‘0’ can be represented by zero seconds) from one facet of the fiber to the other. Keeping track of how the optical power changes as it is propagated down the length of the fiber for this propagation step, the dopant energy population levels are then updated. The new dopant energy level concentrations are in turn applied to the optical power propagation calculation for the next sample power at the following time step. The process is repeated through to ‘N−1’ time steps (in a consecutive manner). The calculation for the time step ‘j’ (where ‘j’ is some discrete time step in the region ‘1’ to ‘N−1’) cannot be calculated until the dopant energy population densities are known up till time step ‘j−1’ (inclusive).

Mathematically, space and time dependent differential equations representing radiation transport of the optical power (for each wavelength component of the propagating optical pulse) and dopant concentration rate equations respectively, are solved in time and space in the retarded reference frame. The retarded reference frame is a coordinate transformation as described in FIG. 2 where the time 3 is expressed as a function of the laboratory time 4, space 2, and optical pulse group velocity 5. For a particular simulation time step, each propagated power (wavelength component) is amplified or absorbed when it interacts with a longitudinally distributed concentration of fiber dopants. As expressed above, the modified optical powers are in turn used to calculate the change in the distributed dopant concentration via the rate equations. This calculation method is an industry standard for calculating active physical effects in fiber amplification simulations. However, by design and mathematical limitation, the shooting method cannot take into account all the important physical effects on a pulse such as GVD described next.

The SSFM is a standard algorithm used to simulate passive effects such as GVD and self-phase modulation (SPM) on a propagating pulse. The calculation process does not depend on the current state of the dopant concentrations at any of the energy levels and breaks away from a ‘causal’ form of calculation. The SSFM is an algorithm that applies the nonlinear Schrodinger (NLS) equation in order to model the complex valued amplitude of a propagating optical pulse. The NLS equation is defined in FIG. 1, where 1 is the complex valued amplitude that is a function of variables space 2 and time 3. The calculation of passive effects on an optical pulse as it propagates is made instantaneously over all time points ‘0’ to ‘N−1’ from one spatial position to the next. The physics and form of calculation is significantly dissimilar from how the shooting method is designed to work. In fact, the numerical process of SSFM is ‘acausal’ (see Reference 3).

Reference 1 has additional details on these standard numerical methods of optical fiber amplification.

The aforementioned algorithms are very powerful for their niche of physical effects. However, in nature, the effects taken into account by each of these algorithms are not mutually exclusive events, and a connection needs to be made such that both active and passive effects are accurately taken into account. The following example illustrates the numerical paradox when attempting to simulate using both of these algorithms for an experiment where effects of gain and GVD are significant.

Let us begin by using the shooting method to calculate the amplification of a particular power sample of the optical pulse at a particular time. In FIG. 3, at the current time τ₀ described by item 7, the power sample is propagated down the fiber from the spatial position z (item 8) to z+dz (item 9), where z is the current longitudinal position in context, and dz is the length for this sample to be propagated next (item 10) down the length of the optical fiber. Here, optical gain is being accounted for. In order to include the GVD effect on the same optical power sample for that time and spatial step, one may consider utilizing the SSFM algorithm. However, SSFM requires the remaining power samples after (or in the future of) the time step τ₀ (item 7 in FIG. 4) to be known, all of which have not yet been calculated by the shooting algorithm (in FIG. 3) and therefore cannot be provided for propagation to spatial position z+dz (item 9). It is therefore evident that in order to simulate both passive (GVD) and active (optical gain) effects simultaneously, one cannot utilize the shooting and SSFM methods in any obvious way due to their incompatibility in requirements at the time of the calculation. The converse is also not an applicable approach.

Suppose that GVD is to be calculated as one of the physical effects on a propagating pulse utilizing the SSFM algorithm. The GVD effect on the entire pulse, defined as a function of time, cannot be calculated at once if, at each step in time, changes are made to the attributes of the pulse due to active effects from the shooting method that would inevitably change the future time samples of this propagating optical pulse.

It is the primary objective of the present invention to provide an optical fiber amplification method that can accurately account for optical gain and group velocity dispersion simultaneously so that there is no numerical paradox as described above.

### BRIEF SUMMARY OF THE INVENTION

Hitherto, there is no theoretical or numerical process that performs both active and passive calculations on an optical pulse simultaneously as it propagates down an optical fiber amplifier. Generally, this would require a method that can accommodate physical effects considered in both ‘causal’ and ‘acausal’ methods.

A method for numerical optical fiber amplification is presented for the purpose of facilitating simultaneously passive effects such as GVD, when performing active calculations such as optical gain on a propagating optical pulse or optical pulse train in an optical fiber amplifier.

### BRIEF DESCRIPTION OF THE SEVERAL VIEWS OF THE DRAWING

FIG. 1 The Nonlinear Schrödinger (NLS) Equation with time and space dependent optical gain coefficient.

FIG. 2 The coordinate transformation from laboratory time and space to the retarded reference frame.

FIG. 3 Shooting Method propagates a power sample down the length of the optical fiber through a series of spatial steps, where the domain represents the length of the optical fiber amplifier.

FIG. 4 Split-Step Fourier Method propagates all of the signal samples at the same time from one spatial position to the next where the domain represents the length of the optical fiber amplifier.

FIG. 5 The generation of complex valued amplitude that includes simultaneous GVD and optical gain effects.

FIG. 6 The generation of the complex amplitude A(z,τ) as output from the PT module for a distinct time τ=τ₀ and position z in the optical fiber amplifier.

FIG. 7 An extended NLS equation having a space and time dependent optical gain.

FIG. 8 Block diagram description of the PT module. The simultaneous passive and active effects are calculated for the updated amplitude by an additional sub-module described in FIG. 9.

FIG. 9 The GGS module is presented for the case of optical gain GVD and SPM effects being considered in a simulation.

### DETAILS OF INVENTION

The embodiment of the software algorithm is named the Modified Complex Power (MCP) method. It is assumed that the input into the optical fiber amplifier is a train of optical pulses, and that the software implementing the MCP method includes a means to keep track of how the system interacts with this train of propagating pulses in the optical fiber amplifier cavity.

MCP makes use of a set of differential equations that are applied in the numerical calculation. These are the set of equations used by standard SSFM and shooting algorithms when the latter is applied for radiation transport and the calculations are for propagation down an optical fiber. All equations in the MCP algorithm must be in the same reference frame, specifically, the retarded reference frame (See Reference 2 and Reference 3). A coordinate transformation (FIG. 2) is therefore applied to the laboratory time and space dependent partial differential equations (i.e. radiation transport equations) and in turn utilized by the shooting method. The resultant set of ordinary differential equations combined with the NLS differential equation used by the SSFM algorithm (see Chapter 2 of Reference 1) are the set of ordinary differential equations in the retarded reference frame applied in the MCP numerical method.

The novelty of the MCP method is not in the underlying differential equations, which are standard. It is in the approach to calculating a time and space dependent optical gain function and in turn, its application.

It is most convenient to begin the description of the MCP method by considering its numerical simulation of the physical effects on an in-between pulse (i.e. not the first pulse in a sequence of one or more pulses that compose the input signal) propagated through the fiber during simulation.

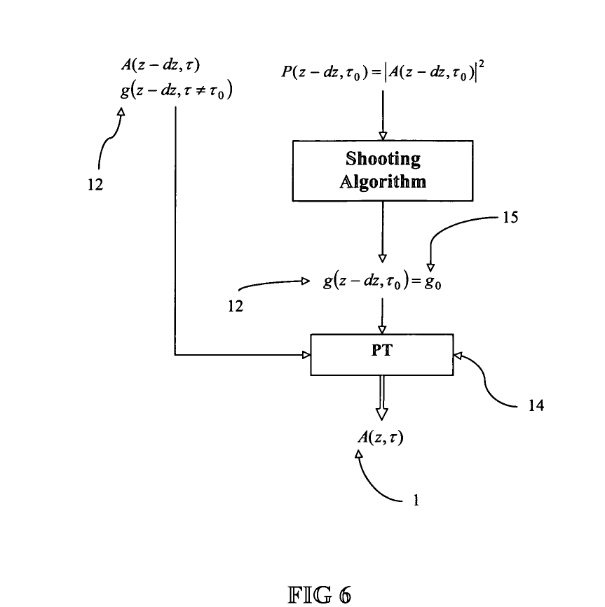

In modeling an optical fiber, one can discretize its length as illustrated in FIG. 5 where 11, 1 and 12, are the power P, complex valued amplitude A, and optical gain g at space 2 and time 3. In this illustration, the calculation is in the process of solving for the complex valued amplitude at the neighboring spatial position 2. The internal workings of item 13 are described in FIG. 6.

To get the gain constant for the power sample at some time τ=τ₀ as it propagates between adjacent spatial steps, one can utilize the shooting algorithm discussed earlier. As illustrated in FIG. 6, to achieve the corresponding complex valued amplitude 1 for that same time (where in general, the power is theoretically equal to the square of the complex valued amplitude P(z,τ)=|A(z,τ)|²) the calculation is more involved and this is where the MCP algorithm is needed. Specifically, one must execute the passive transform (PT) module 14, as shown in FIG. 6 after the gain constant 15 is calculated by the said shooting method. The information carried by complex valued amplitude when it is output from the PT module 14 includes GVD and optical gain effects.

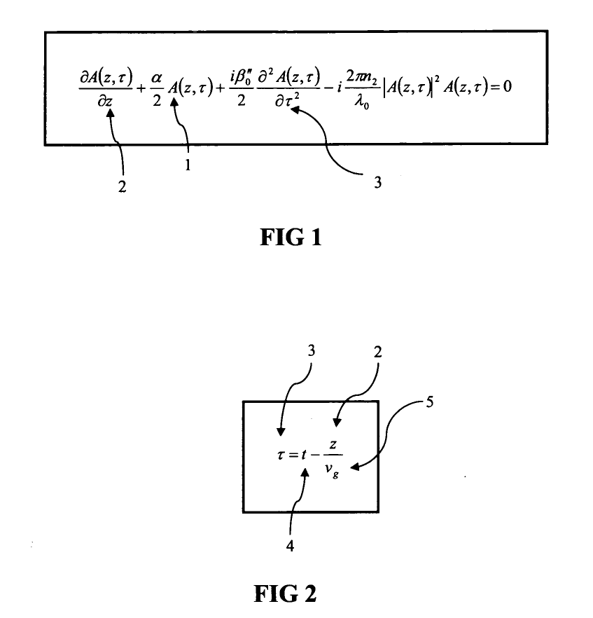

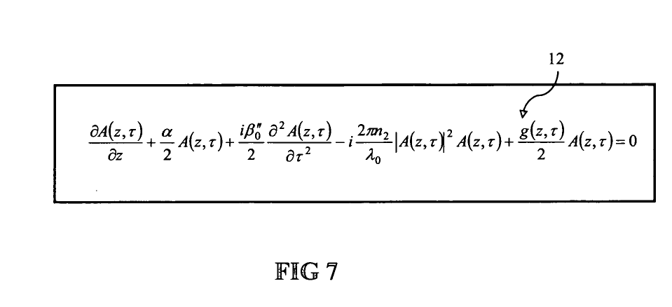

In general, the PT module 14 extends the (passive) NLS Equation (See Reference 1) as defined in FIG. 1 with a space and time dependent optical gain g(z,τ) function as illustrated in FIG. 7, item 12.

The novel contribution of the PT module and therefore the MCP method, is in the numerical generation of the optical gain g(z,τ) which is space and time dependent. Note that this expression is multiplied by a factor of one half (FIG. 7) and this value can be generalized to some other constant.

MCP algorithm methodology collects historical data on how previous pulses interact with the system. This information is used to define the acausal part of the function, the optical gain g(z,τ).

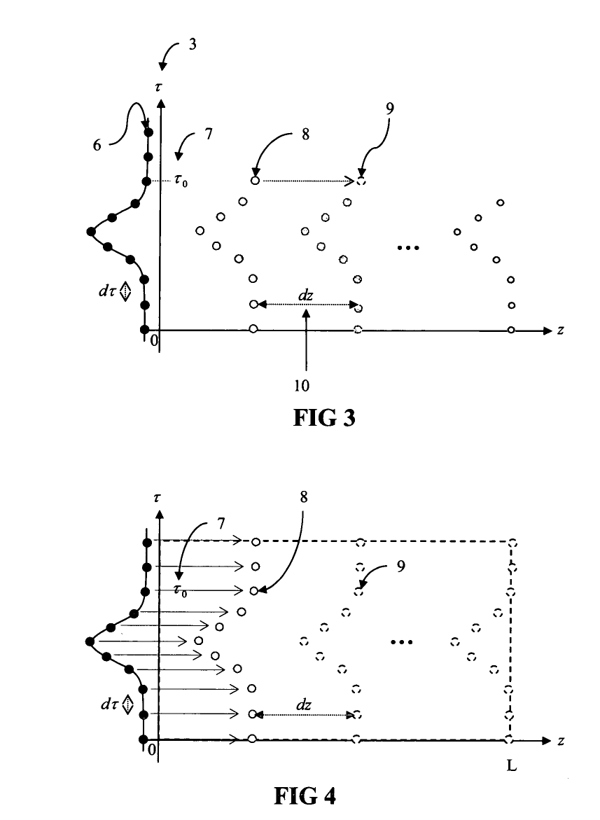

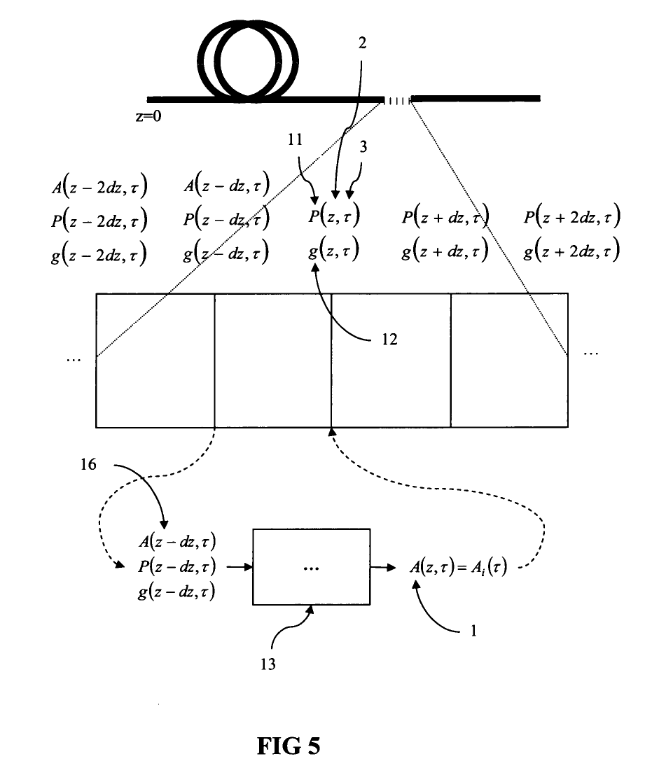

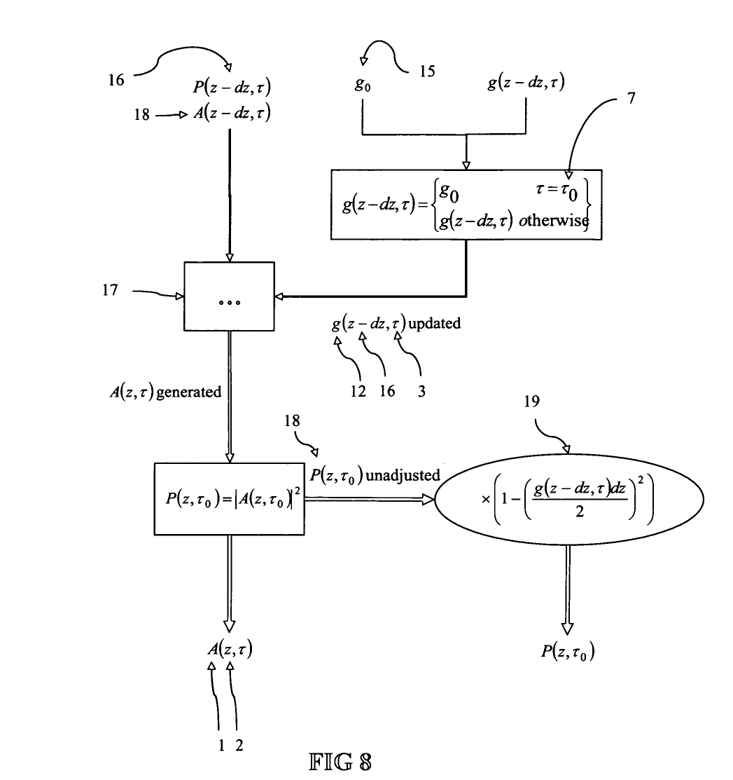

The following is a list of boundary conditions for the calculation of complex valued amplitude 1 in FIG. 8 with passive and active effects considered simultaneously:
1. Assume that the launched input signal to the fiber is a train of identical or similar optical pulses with respect to their envelope distribution in time.
2. Let τ (item 3) start from 0 seconds for each pulse (as also illustrated in FIG. 3. Once the simulation reaches the tail of the pulse, time τ is reset to zero indicating that the next pulse in the series is in the process of being launched into the optical fiber.
3. The launched input complex valued amplitude A(0, τ)≡A(0,t) (and therefore the corresponding power) for each optical pulse in the pulse train is defined.
4. When the MCP method is being used to calculate the complex value amplitude at the z position 2 the complex valued amplitude and power at the z−dz position 16 of the pulse is known for all steps in time τ. If the position 16 is at the launching fiber facet (i.e. z−dz=0), then the amplitude 18 is instantiated with the given input signal A(0,τ) defined above. Note that the complex valued amplitude at z−dz position 16 A(z−dz, τ) is a partially complete solution to the amplitude (at that position and time) until all the time steps are completed for the pulse (discussed further below).
5. The gain constant, 15, g(z−dz, τ₀)=g₀ is known using the shooting algorithm by propagating the optical pulse power P(z−dz, τ₀) (i.e. from position z−dz to z) as discussed earlier using FIG. 6.
6. The optical gain function 12 maintains all the constants up till the current time and for all of the spatial discretization points. That is, g(z−dz, τ<τ₀) is known for the current pulse.
7. The optical gain function 12 retains those gain constants that were already calculated at position 16 for the previous pulse in the sequence of propagating pulses for time steps not reached yet in the current pulse propagation calculation.

After executing the PT module (FIG. 8, and also item 14 in FIG. 6), the amplified complex valued amplitude 1 is calculated at position 2 and the optical gain function is also updated at position 16 and time step 7 which, as will be described shortly, used to calculate the optical gain effects from complex valued amplitude propagation from position 16 to position 2 (i.e. from position z−dz to z ).

By borrowing gain coefficients (only for future time steps τ>τ₀) from a preceding pulse in the pulse train one can construct the necessary optical gain function 12 accurately enough to satisfy the extension of the NLS equation as described earlier in FIG. 7, and consequently solving the simultaneous active and passive effects on an optical pulse as it propagates down the optical fiber amplifier. This is only possible because the methodology has defined a tentative gain for all steps in time.

Assuming that the gain does not differ significantly after the numerical system (representing a doped optical fiber amplifier) approaches steady state (between similar or identical propagated pulses), all the internal cavity, input, and output optical signals converge.

The internal logic of the PT module as it is illustrated in the block diagram of FIG. 8 is further composed of blocks including module 17. After the optical gain function is updated at position 16 at the current time step 7 by replacing the latent entry to the current gain constant 15, it is then utilized in the amplification of the complex valued amplitude at position 16 for the entire pulse from position 16 to position 2 (i.e. z−dz to z).

Ideally, the square of the complex valued amplitude and the power 18 are identical. However, the accuracy of the squaring of the generated complex valued amplitude is not perfect due to some approximations resulting in errors when the spatial step dz is too large. To accommodate these errors, a correction factor 19 is introduced as indicated in the last operation of FIG. 8. This correction factor is in no way unique. It is just one of many possible correction factors that can be used in the MCP methodology.

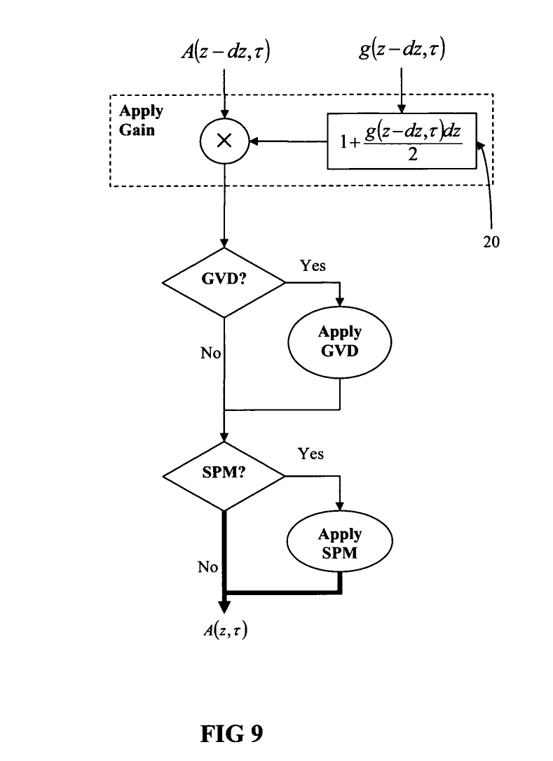

When the complex valued amplitude at position 16, A(z−dz,τ), is sent into module 17, it is propagated to position 2 (i.e. z) by a series of operations, and these are illustrated in FIG. 9 as the active effects such as optical gain and passive effects such as GVD and self-phase modulation (SPM) respectively. These calculations are all straightforward because the time and space dependent optical gain function 12 is already updated. A multiplication for all steps in time of the input complex valued amplitude by a function of the optical gain 20 is applied. Then if any passive effect such as GVD or SPM is required, these effects are applied on the resulting amplified complex valued amplitude in the same way one would apply these effects when using the SSFM algorithm.

When initializing a simulation, the first pulse in the train of input pulses are propagated for all the optical pulse samples by using only the shooting algorithm exclusively to generate non-zero gain coefficients for all of time and space for the first pulse. This provides realistic (i.e. nonzero) boundary conditions and is used as historical data for generation only of the second pulse. The optical gain data calculated for the second pulse will in turn be used as historical data for the third pulse using the MCP method, and so on until the last pulse.

The following pseudo code summarizes the general steps of the MCP algorithm. Constants ‘N’, ‘NSTEPS’, and ‘SIMREPS’ represent the total (integer) number of time domain samples of a current pulse, the total number of spatial steps in the fiber separated by distance 10 described in FIG. 3 and the number of pulses in the pulse train respectively. The indexing is based on the C/C++ standard (i.e. starting with 0).
1. INITIALIZE: the optical gain function g(z,τ) for all space and time by exclusively utilizing the shooting algorithm with the first pulse in the sequence of input pulses.
2. FOR: current pulse=1 to (SIMREPS-1)
3. FOR: each consecutive time step (i.e. τ=τ₀=0, dt, 2dt, . . . , (N−1)dt)
4. FOR: each consecutive spatial step (i.e. starting at the first displacement z=dz, 2dz, . . . , (N−1)dz)
5. IF: propagating from the first spatial step, then set the power to the square of the input complex valued amplitude sample (i.e. z==dz then set P(0,τ₀)=|A(0, τ₀)|²) of the current pulse, ELSE: solve for the gain constant g₀ using the optical pulse power sample from the previous spatial step P(z−dz, τ₀) via the shooting algorithm.
6. Execute the PT module to generate the complex valued amplitude A(z, τ).
7. Calculate the corresponding optical pulse power sample.
8. END FOR:
9. END FOR:
10. END FOR:

The embodiments of the invention in which an exclusive property or privilege is claimed are defined as follows:

1. An optical amplification method that models for a given time step the active and passive effects on a complex valued amplitude of an optical pulse where said complex valued amplitude is defined for all time steps as it propagates a finite longitudinal distance from a given current position down an optical fiber amplifier, the amplification method comprising: Update of time and space dependent optical gain at said time step and said position by replacing the value with a gain constant generated by means of propagating the square of the said complex valued amplitude at said time step by said longitudinal distance and by extracting the said gain constant, applying said optical gain and group velocity dispersion to the said time dependent complex valued amplitude by said longitudinal distance.

2. An optical amplification method that further embodies said numerical method of claim 1 and models the simultaneous active and passive effects on a sequence of one or more optical pulses as they are launched and propagated in an optical fiber amplifier and includes the account of optical gain and group velocity dispersion by data retention means for keeping track of said optical gain and optical pulse complex valued amplitude simulation data as the calculations are progressed, where said optical gain defined at discrete points in time and space and is updated and utilized by applying the numerical method of claim 1 when propagating said optical pulse or pulses from one position to the next in said optical fiber amplifier.

3. The numerical method of claim 1 where optical gain is applied to the time-dependent complex valued amplitude by using the following chronological mathematical operations for all time steps: Multiply optical gain at said position by said finite longitudinal distance, divide result by two, add result by one and multiply result by said complex valued amplitude.

4. The numerical method of claim 1, wherein to calculate for propagated optical power of the optical pulse, after propagation the square of the complex valued amplitude of the optical pulse is modified by a correction factor.

5. The calculation method of claim 4, where the correction factor modifies the square of the complex valued amplitude of the optical pulse according to the following chronological mathematical operations for all time steps: Multiply optical gain at said position by said finite longitudinal distance, divide result by two, square result, subtract result from unity and multiply result by said square of the complex valued amplitude.

6. The numerical method of claim 1, wherein the optical pulse transport equations are defined in the retarded reference frame after a coordinate transformation τ=t−z/ν_{g} where τ, t, z and ν_{g} are the laboratory time, relative time, space and optical pulse group velocity respectively.

7. The numerical method of claim 2, wherein the optical pulse transport equations are defined in the retarded reference frame after a coordinate transformation τ=t−z/ν_{g} where τ, t, z and ν_{g} are the laboratory time, relative time, space and optical pulse group velocity respectively.

8. The numerical method of claim 2 where the optical fiber amplifier is doped with any combination of rare-earth elements including Ytterbium, Thulium and/or Erbium atoms.

9. The numerical method of claim 2 where the optical fiber amplifier has a core and a series of one or more outer layers of cladding with arbitrary cross-sectional geometry.

10. The numerical method of claim 2 where a data retention of optical gain retains the gain constants from the previously propagated pulse in the signal sequence if those gain constants have not yet been overwritten in said optical gain by the calculation of the gain constants for the current pulse.

11. The numerical method of claim 2 where the input sequence of one or more optical pulses are either identical, or similar.

12. The numerical method of claim 2 where each pulse in the input sequence of one or more optical pulses have a Gaussian, or Gaussian-like power distribution.

13. The numerical method of claim 2 where active effects include Stimulated Raman Scattering, and Stimulated Brillouin Scattering.

14. The numerical method of claim 2 where passive effects include Self Phase Modulation, Four Wave Mixing.

15. The numerical method of claim 2 where passive effects include those physical effects that can be calculated in the Split-Step Fourier Method.

16. The numerical method of claim 2 where the input signal is frequency chirped.
